(19) United States
(12) Patent Application Publication
(10) Pub. No.: US 2025/0053192 A1
(43) Pub. Date: Feb. 13, 2025

(54) DOCUMENT HOLDER

(71) Applicant: ID Talon, LLC, Lino Lakes, MN (US)

(72) Inventor: Benjamin Knitter, Lino Lakes, MN (US)

(21) Appl. No.: 18/366,462

(22) Filed: Aug. 7, 2023

(51) Int. Cl. G06F 1/16; F21V 33/00

(52) U.S. Cl. CPC G06F 1/1611; F21V 33/0048; F21Y 2103/10; F21Y 2115/10

(57) ABSTRACT

A document holder for holding a document, or, in dim or dark situations, illuminating a document, relative to an electronic screen is provided. The document holder has a mountable frame with at least one light, preferably a green light. The mountable frame has a base having a top, a bottom, a first face and a second face; a first flange extending in a first direction from the top of the base; a second flange extending in the first direction from the top of the base, the second flange having a lighting fixture with at least one light; and a coupler.

### BACKGROUND OF THE INVENTION

The present disclosure relates to novel and advantageous document holders for emergency, government, and security officers who may need to review documents at night.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Police officers, security officers, immigration officers, federal agents, emergency medical technicians, firefighters, other government agents, and others regularly need to obtain identification documents, like a driver's license, or other documents while they are doing other activities on a computer or electronic device such as conducting a search, creating a report, or otherwise entering information via the electronic device. This work may take place in dark or dim lighting, often at night.

As computers and other electronic devices have become increasingly commonplace as part of these agents' activities, there is no place to secure identification documents or other documents while running computer checks during, for example, a traffic stop. Typically, police officers are holding identification documents in one hand while running checks or setting it somewhere in their car where it may fall into a crevice or between seats. In addition, the police officer is often conducting these traffic stops at night, and the police car's dome light or other available lights may not be suitable. Further these lights may diminish night vision of the police officer while in the police car, illuminating the officer and potentially resulting in a loss of tactical advantage.

It would be desirable to provide a rigid holder that is adaptable to officers' use of computer or mobile technology, and in some further cases to be removable.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In at least one embodiment, a document holder comprises a mountable frame and a lighting fixture having at least one light disposed within the mountable frame. The mountable frame comprises a base having a top, a bottom, a first face and a second face; a first flange extending upward from the top of the base; and a coupler. The mountable frame may further comprise a second flange extending upward from the top of the base; and a gap between the first flange and the second flange. An identification card, an insurance card, or other documents may be inserted into the gap, and held there while the officer or agent enters information into a computer or other electronic device. The document holder may be mounted to the electronic device, or in other situations may be mounted to a portion of the officer or agent's vehicle. In some embodiments, the mountable frame may further comprise at least one projection extending upwards from the top of the base between the first flange and the second flange.

In some embodiments, the lighting fixture may be disposed within the second flange. One or more of the lights used within the lighting fixture may be a green light that can help illuminate the document while not providing the same tactical disadvantage that a bright light, dome light, or flashlight may provide. In some embodiments, the lighting fixture may be a LED lightstrip having at least one LED light, and at least one of the LED lights is a green light. In some embodiments, the lighting fixture could also have a coating, and the coating is green.

The document holder may be coupled to an electronic device or a portion of the officer or agent's vehicle, and the mountable frame may have a coupler. The coupler may be a hook and loop fastener, an adhesive strip, a magnetic strip, or other similar coupling devices that can removably attach the mountable frame to the electronic device, a screen of the electronic device, or a portion of the officer or agent's vehicle. In at least one embodiment, the coupler is on the second face.

In some embodiments, a document observation system comprises an electronic device such as a laptop, smartphone, or a vehicle console screen and a document holder removably mounted to the electronic device. The document holder may comprise a frame having a base with a top, a bottom, a first face and a second face; a first flange extending upward from the top of the base; a coupler for mounting to the electronic device and a lighting fixture, where the lighting fixture may be disposed on a surface of the frame. In some embodiments, the document holder is flush mounted to a surface of the electronic device. The lighting fixture may have at least one light, which can be a green light.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a plan view of a document holder according to at least one embodiment of the present invention of the disclosure.

FIG. 2 is a side view of the document holder of FIG. 1.

FIG. 3 is a plan view of a document observation system having the document holder similar to that of FIG. 1 mounted to a laptop device or other electronic device, according to at least one embodiment of the present invention of the disclosure, and shows a document held within the document holder.

FIG. 4 is a side view of the document holder mounted to the laptop device of FIG. 3, and also with a document held within the document holder.

FIG. 5 is a plan view of a document observation system, according to at least one embodiment of the present invention of the disclosure, and shows a document held within the document holder.

FIG. 6 is a plan view of a document observation system, according to at least one embodiment of the present invention of the disclosure, and shows a document held within the document holder.

FIG. 7 is a plan view of a document observation system, according to at least one embodiment of the present invention of the disclosure, and shows a document held within the document holder.

FIG. 8 is a side view of the document holder mounted to the laptop device of FIG. 7, and also with a document held within the document holder.

### DETAILED DESCRIPTION

The present disclosure describes novel and advantageous document holders that are capable of holding, and illuminating, identification documents or other similar documents while an officer, emergency medical personnel, or other agents or officers try to enter information from the documents into a computer or other electronic device. The embodiments of this invention allow officers or agents to have their eyes ahead for their own safety and to be able to detect hazards ahead of them, while still allowing them to do their work. It also allows for easier transcription of the material on the identification documents or other similar documents, like insurance cards.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, and/or components have not been described in detail so as not to obscure the discussion. Further, it is understood that elements on the figures having like reference numerals (e.g. 162 and 462) may have any or all of the features as earlier described for such elements.

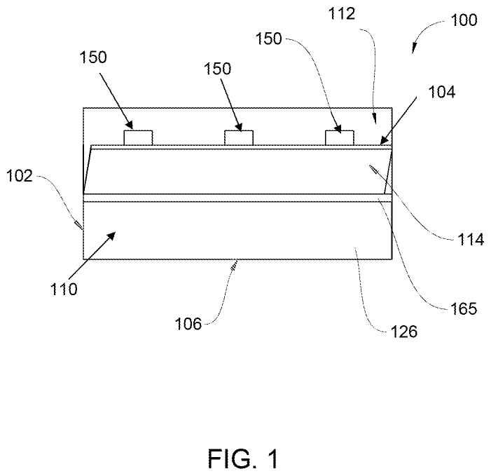

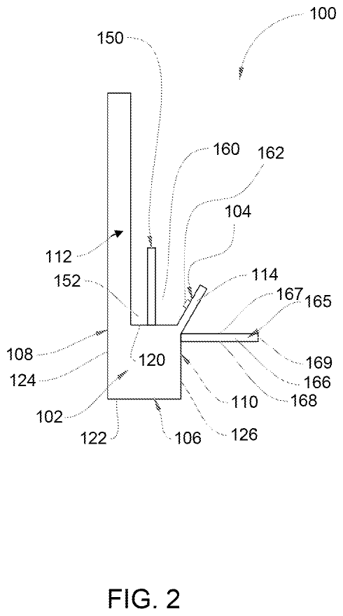

In at least one embodiment, as shown in FIGS. 1-2, the low-profile document holder 100 comprises a mountable frame 102 and a lighting fixture 104 attached to the mountable frame 102. In some embodiments, the mountable frame 102 comprises a base 106 with a first end 108 and a second end 110, and a first flange 112 extending upward from the base at or near the first end 108. The first flange 112 extends upward from the base at a first height. In some embodiments, the mountable frame further comprises a second flange 114 at or near the second end 110 and a gap 116 between the first flange 112 and the second flange 114 whereby an identification card can rest on the base 106 within the gap 116 between the first flange 112 and the second flange 114. The second flange 114 extends upward from the base 106 at a second height. The second height may, in some embodiments, be less than the first height of the first flange 112. This helps with the visibility of the identification document.

The base 106 may comprise a top 120, a bottom 122, a first face 124 at the first end 108, and a second face 126 at the second end 110.

In some embodiments, the base 106 may have one or more fingers 150 extending upward from the top of the base. The fingers 150 may be positioned within the gap 116 and may be between the first flange 112 and the second flange 114. The fingers 150 may help hold the identification document securely. Each finger has a height less than the first flange 112. In some embodiments, the fingers 150 comprise a flexible plastic or spring loaded clamps. A channel 152 may be defined between the fingers 150 and the first flange 112, and a user can insert the identification document in and out of the channel 152 with one hand. The channel 152 may be able to accommodate multiple identification documents at one time; for example, the channel 152 may hold at least 4 identification documents stacked together.

The lighting fixture 104 is attached to the second flange 114 and may comprise a single light 162 or, as shown in FIG. 1, may comprise more than one light 162. In some embodiments, the lighting fixture 104 may comprise a strip of light emitting diodes (LEDs). In some embodiments, the LEDs are dimmable LEDs. In at least one embodiment, the light or lights of the lighting fixture 104 emit a green light or are green LEDs. Green-colored lighting is preferable because it does not affect night vision as severely as white light, provides far better ability to read details than other spectrums of light like red light. In some embodiments, only one of the lights 162 of the lighting fixture 104 emit a green light. In some embodiments, the green light use a wavelength between 495 nanometers and 570 nanometers. In some embodiments, the lighting fixture 104 has a colored coating or colored film. In at least one embodiment, the colored coating or colored film is green. In other embodiments, UV lighting could be used to be able to verify the ultraviolet markings. The lighting fixture 104 is positioned on the frame at an angle θ relative to the top 120 of the base 106. In at least one embodiment, the angle θ is between 90 degrees and 135 degrees. In some embodiments, the angle θ is between 90 degrees and 105 and 120 degrees. The light emitted from the lights 162 of the lighting fixture is minimized based on the lights used and the angle θ so as to light just the identification document, which reduces the amount of light entering the officer or agent's pupils and protects their night vision. By lighting just the document, it also limits illumination of the officer which can make them more visible and susceptible to hazards. In circumstances where night vision may not matter as much, but the document holder is still helpful, the lighting fixture may use white light instead of green light, for example, in doctor's offices, customs check points, or at the DMV. Importantly the light fixture is positioned so that the light is directed away from the user. The lighting fixture can be powered by a rechargeable battery source disposed within the mountable frame (more particularly, within the base of the mountable frame) or by connecting the document holder to the vehicle's battery source (e.g. through a USB port, 12V receptacle or other charging source in the vehicle).

In at least the embodiment shown in FIGS. 1-2, the low-profile document holder 100 further comprises a coupler 165 for mounting the document holder 100 to the electronic device. In at least one embodiment shown in FIGS. 1-2, the coupler 165 comprises a third flange 166 extending outward from the second face 126 of the base 106. The third flange 166 has an outer surface 167 and an inner surface 168. In at least one embodiment, at least one of the second face 126 and the inner surface 168 has a fastener, an adhesive layer or magnet that allows for attachment of the document holder 100 to the electronic device. In some embodiments, the adhesive layer may further comprise a portion of a hook and loop fastener. The coupler 165 may further comprise an end 169 that when the document holder 100 is mounted or attached to the electronic device, the end 169 is flush with a surface of the electronic device and therefore permits the electronic device to be closed without removing the document holder 100. In other embodiments, the coupler 165 is removably mounted or removable attached to the electronic device.

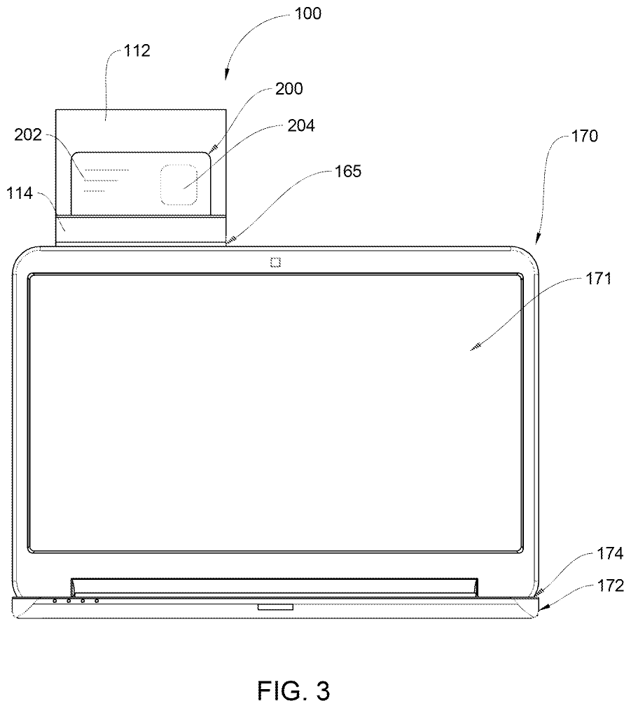

FIG. 3 shows the low-profile document holder 100 attached to an electronic device 170, in this case, shown as a laptop, but the electronic device could be any electronic device including a smartphone, tablet, or an integrated vehicle electronic console having a screen. In some embodiments, the document holder 100 is fixedly attached to an electronic device 170 with the coupler 165. In other embodiments, the document holder 100 can be removably mounted to an electronic device with the coupler 165. Electronic device 170 may have a screen component or monitor 171 and a base 172 which pivots relative to a screen with hinge 174. As discussed above, the coupler 165 is configured to allow the screen to be in an open or closed position relative to a base or cover without having to remove the document holder 100 from the electronic device 170. As shown in FIG. 2, the document holder 100 is retaining document 200, which may have some written or visual information 202 and a photo 204. Light from the lighting fixture mounted to flange 114 illuminates the document 200, including, as needed, the photo 204 or the written or visual information 202.

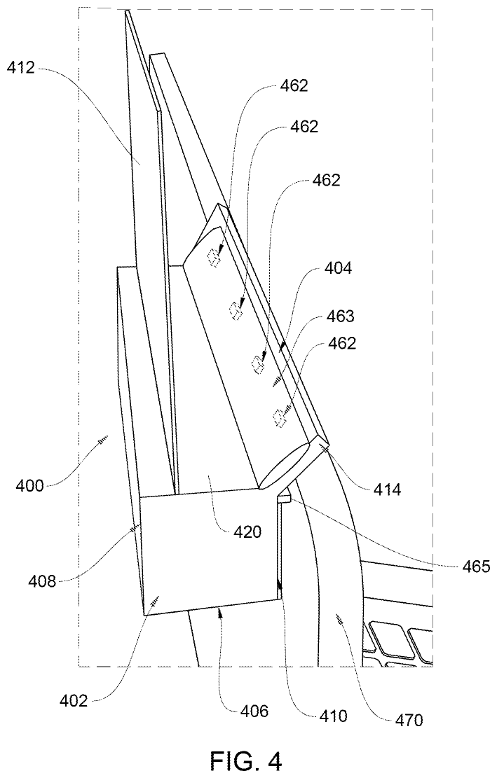

FIG. 4 shows an embodiment of the document holder 400 comprising a mountable frame 402 and a lighting fixture 404 attached to the mountable frame 102. In this embodiment, the lighting fixture 404 comprises multiple lights 462, such as light-emitting diodes (LEDs), mounted onto a lighting strip 463. The lighting strip 463 is then mounted to the flange 414 such that the lighting strip 463 is positioned at a desired angle relative to the mountable frame 402.

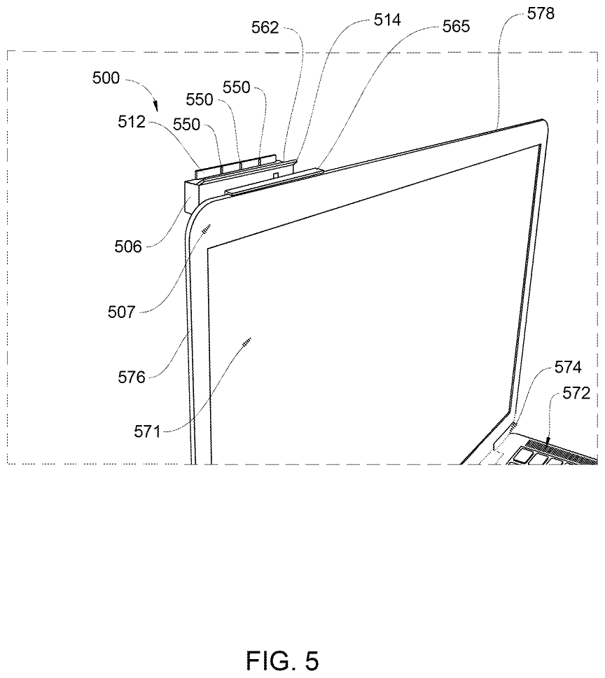

FIG. 5 shows another embodiment of the mountable frame 500, as discussed above with respect to FIGS. 1-4, however, in this embodiment (shown mounted onto electronic device 570) the coupler 565 is a C-shaped flange 566 extending outward from the second face 526 of the base 506. The flange 566 has an outer surface 567 and an inner surface 568. In at least one embodiment, the inner surface 568 has a fastener, an adhesive layer or magnet that allows for attachment of the document holder 500 to the electronic device. In other embodiments, the C-shaped flange 566 does not have any fastener, adhesive layer or magnet, and instead relies upon gravity to maintain the connection between the frame 500 and the electronic device 570.

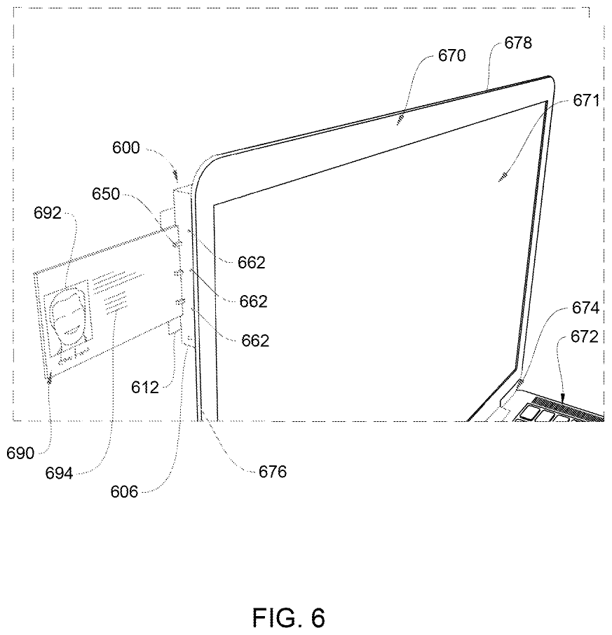

FIG. 6 shows another embodiment of the mountable frame 600, as discussed above with respect to FIGS. 1-4, this time mounted to the side of the electronic device 670. Like the other embodiments described herein, fingers 650 are spring-like to provide a clamping force to retain the document 690, which may have a photo 692 and some written or other visual information 694, within the mountable frame. The lights 662 illuminate the document 690, and in particular the information 694 and the photo 692.

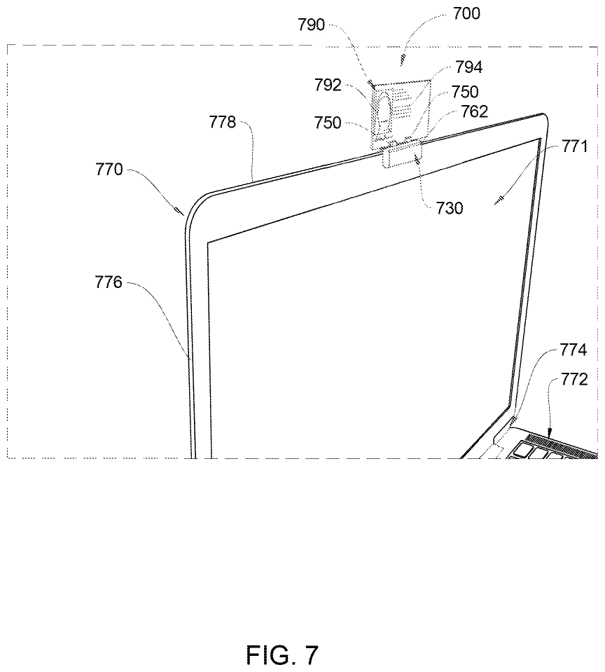

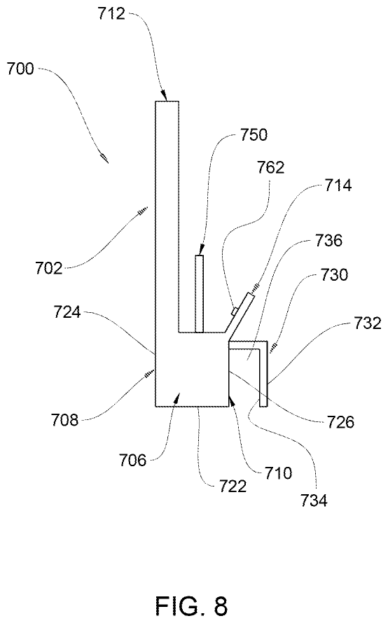

In still other embodiments, such as the embodiment shown in FIGS. 7-8, the document holder 700 can be clamped onto the electronic device, which means a user can remove it from one vehicle or electronic device and use it elsewhere. However, where the electronic device is a laptop, the clamped version may not allow the laptop computer to be closed all the way. In this embodiment, the mountable frame 702 comprises a base 706 with a first end 708 and a second end 710, and a first flange 712 extending from the base at or near the first end 708. The base 706 may comprise a top 720, a bottom 722, a first face 724 at the first end 708, and a second face 726 at the second end 710. The mountable frame further comprises a clamp 730 at the second end 710 of the base. In some embodiments, the clamp 730 may be spring-loaded. It may be desirable that the spring of the clamp 730 has a relatively low tension to prevent damage to the computer. In other embodiments the clamp 730 may adjust its position relative to the base 706 by a sliding mechanism. The clamp 730 may have a C-shape or a clamshell-like design, but may have other configurations. The clamp 730 has an outer surface 732 and an inner surface 734. The inner surface 734 may be coated with an anti-skid coating, such as an elastomer or rubber coating. The inner surface 734 may be configured with a rounded contact area so that the clamp 730 can accommodate different sized monitors or devices. A gap 736 exists between the inner surface 734 and the base 720, and more particularly the second face 726. The clamp 730 may open and close to widen or narrow the gap 736. The electronic device 770 is inserted into the gap 736 and tension of the clamp 730 maintains the position of the document holder 700. To remove the document holder 700 from the electronic device 770, the pressure of the clamp 730 is relaxed to widen the gap 736 until the document holder 700 is no longer engaged with the electronic device 770.

In still other embodiments, the document holder may be integrally formed within the electronic device, such as the monitor, laptop, smartphone, or vehicle's console. The integrally formed document holder has a frame with a gap between a first sidewall and a second sidewall of the frame. An identification document can rest within the gap of the frame. A lighting fixture comprising at least one light, and preferably a green light, may be installed in the second flange of the frame to illuminate the gap. The lighting fixture could be powered by the battery or power source of the electronic device.

In at least one embodiment, the mountable frame may comprising a scanning device for reading information from the identification documents or other documents. In at least one embodiment, the mountable frame receives short-range electromagnetic waves from the identification device using near field communication technology. In some embodiments, the mountable frame has chip reading technology.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As used herein any reference to “one embodiment” or “an embodiment” means that 6a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising.” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments for purposes of illustration only. One skilled in the art will readily recognize from the discussion herein that alternative embodiments of the structures and methods illustrated herein may be employed without departing from the principles described herein.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While the systems and methods described herein have been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

What is claimed is:

1. A document holder comprising:
a mountable frame, the mountable frame comprising:
a base having a top, a bottom, a first face and a second face;
a first flange extending in a first direction from the top of the base;
a second flange extending in the first direction from the top of the base, the second flange having a lighting fixture with at least one light; and
a coupler.

2. The document holder of claim 1, wherein the mountable frame further comprises:
a gap between the first flange and the second flange.

3. The document holder of claim 1, wherein the mountable frame further comprising:
at least one projection extending upwards from the top of the base between the first flange and the second flange.

4. The document holder of claim 1, wherein the at least one light is a green light.

5. The document holder of claim 1, wherein the lighting fixture is a LED lightstrip having at least one LED light.

6. The document holder of claim 5, wherein the at least one LED light is a green light.

7. The document holder of claim 1, wherein the lighting fixture has a coating.

8. The document holder of claim 7, wherein the coating is green.

9. The document holder of claim 1, wherein the coupler comprises at least part of a hook and loop fastener.

10. The document holder of claim 1, wherein the coupler is an adhesive strip.

11. The document holder of claim 1, wherein the coupler is a magnetic strip.

12. The document holder of claim 1, wherein the coupler is on the second face.

13. A document observation system comprising:
an electronic device;
a document holder removably mounted to the electronic device, the document holder comprising:
a frame comprising:
a base having a top, a bottom, a first face and a second face;
a first flange extending upward from the top of the base;
a second flange extending in the first direction from the top of the base, the second flange having a lighting fixture with at least one light; and
a coupler for mounting to the electronic device.

14. The document observation system of claim 13, wherein the document holder is flush mounted to a surface of the electronic device.

15. The document observation system of claim 13, wherein the at least one light is a green light.
